(19) United States
(12) Patent Application Publication
(10) Pub. No.: US 2022/0414893 A1
(43) Pub. Date: Dec. 29, 2022

(54) CAMERA-BASED DETECTION OF TILTING MOVEMENTS

(71) Applicant: ZF Friedrichshafen AG, Friedrichshafen (DE)

(72) Inventors: Markus Birk, Friedrichshafen (DE); Gabriela Jager, Friedrichshafen (DE); Dieter Balz, Wangen im Allgäu (DE)

(73) Assignee: ZF Friedrichshafen AG, Friedrichshafen (DE)

(21) Appl. No.: 17/778,186

(22) PCT Filed: Nov. 9, 2020
(86) PCT No.: PCT/EP2020/081404

§ 371 Date: May 19, 2022

(30) Foreign Application Priority Data
Nov. 21, 2019 (DE) 10 2019 217 988.6

(51) Int. Cl. G06T 7/20; G06V 20/58; H04N 5/77

(52) U.S. Cl. CPC G06T 7/20; G06V 20/58; H04N 5/77; G06T 2207/30252; G06T 2207/10016; G06T 2207/30244

(57) ABSTRACT

The invention relates to a method for recognizing a tilting movement of a vehicle having at least one camera installed on the vehicle The method includes recording an image sequence by the camera, determining an optical flow of the image sequence, determining an optical flow to be expected on the grounds of a travel movement of the vehicle and a topography of the underlying surface, and checking of the optical flow of the image sequence and of the expected optical flow for deviations. A vehicle adapted to perform the method is also disclosed.

### RELATED APPLICATIONS

This application claims the benefit under 35 U.S.C. § 371 as a U.S. National Application of application no. PCT/EP2020/081404, filed on 9 Nov. 2020, which claims benefit of German Patent Application no. 10 2019 217 988.6, filed 21 Nov. 2019, the contents of which are hereby incorporated herein by reference in their entireties.

### FIELD OF THE DISCLOSURE

The invention relates to a camera-based method for detecting tilting movements of a vehicle, and to a vehicle adapted to perform the method.

### BACKGROUND

From the prior art systems are known which prevent the tilting of passenger cars or trucks. These systems stabilize the vehicle by acting upon the brakes and/or the steering of the vehicle.

Floor-level conveyors and building machines often risk tilting over owing to the static displacement of lifted loads. The systems known from the prior art are then ineffective, since they operate dynamically and presuppose a sufficiently quick travel movement of the vehicle.

### SUMMARY

The purpose of the present invention is to improve the tilting safety of vehicles at low speeds. This objective is achieved by a method according to the present disclosure and by a vehicle according to the present disclosure.

The method according to the invention serves to recognize a tilting movement of a vehicle. A tilting movement is a rolling movement, i.e. a rotation movement about the longitudinal axis of the vehicle, or a pitching movement, i.e. a rotation movement about the transverse axis of the vehicle, the result of which is that the balance of the vehicle is lost and the vehicle topples over.

The vehicle is, for example, a wheel loader, a forklift truck, or a dumper. The vehicle comprises a camera. A camera is a means of displaying images of its surroundings on an image-forming medium. Preferably the camera is an optical camera which forms images in visible light. The camera is installed on the vehicle.

The method provides that with the camera a sequence of images is recorded. A sequence of images is a succession of at least two images.

In the image sequence recorded an optical flow is determined. This is a vector field of the speed of visible points of at least one object recorded by the camera, projected in the image plane of the camera.

Besides the optical flow actually present in the image sequence recorded, an optical flow to be expected is determined. The determination is based on a travel movement of the vehicle and a topography of the underlying ground surface. Travel movement is understood to mean a movement of the vehicle relative to the ground surface. The topography of the underlying ground surface is understood to mean its surface condition.

On the assumption that the vehicle is not tilting, by virtue of its travel movement and the topography of the underlying ground surface a movement of the camera relative to the object is clearly established, which is positionally fixed relative to the underlying ground surface. This gives the expected optical flow of the object recorded by the camera.

Finally, it is checked to what extent the actual optical flow present in the image sequence deviates from the expected optical flow. Deviations are an indication of tilting movements of the vehicle.

If by virtue of the deviations of the optical flow the danger of a tilting movement is recognized, countermeasures can be initiated. For example, the speed of the vehicle and/or its steering angle can be reduced. If a load is being lifted, the lifting can be stopped and/or the load can be put down.

In a preferred further development, the step of determining the optical flow to be expected is divided into a number of part-steps. Thus, in order determine the optical flow to be expected, the travel movement of the vehicle is determined. Preferably, the travel movement is determined during the recording of the image sequence. If necessary, the topography of the underlying ground surface is also determined. This can be omitted if the ground surface is flat.

By virtue of the travel movement and the topography, on the assumption that the vehicle is not tilting, a movement of the camera relative to one or more of the objects recorded by the camera, i.e. contained in the image sequence, is clearly defined. In a further part-step this movement is determined. The objects are positionally fixed objects, i.e. ones that are not moving relative to the ground surface. In particular, the underlying ground surface itself can be such an object.

In a last part-step according to this further development the optical flow is determined, which is to be expected owing to the determined movement of the camera.

In a further preferred further development, the part-step of determining an optical flow, to be expected due to the movement of the camera, is again divided into part-steps. In a first part-step the object recorded by the camera is recognized in the image sequence. Appropriate automated or computer-implemented methods for image recognition are known from the prior art by those familiar with the field. In particular neuronal networks or stochastic algorithms can be used for image recognition.

By the recognition of the object in the image sequence an area of the image sequence is identified, in which the object is depicted. In a further part-step the optical flow of that area is determined. This means that it is not the optical flow of the entire image area, but only the optical flow of the object in the image sequence which is determined. In that way the determination is more efficient and interferences, for example by moving objects or people, are avoided.

In a further part-step a corresponding optical flow of the object in the image sequence, which is to be expected due to the movement of the camera, is determined. In detail, the optical flow in the above-mentioned area in which the object is depicted, that is to be expected owing to the movement of the camera, is determined.

A vehicle according to the invention comprises at least one camera and at least one evaluation unit, which implements the method according to the invention or a preferred further development thereof, i.e. which is designed to carry out such a method.

A preferred example embodiment of the invention is illustrated in FIG. 1, which shows in detail:

### BRIEF DESCRIPTION OF THE DRAWING

FIG. 1: A vehicle.

### DETAILED DESCRIPTION

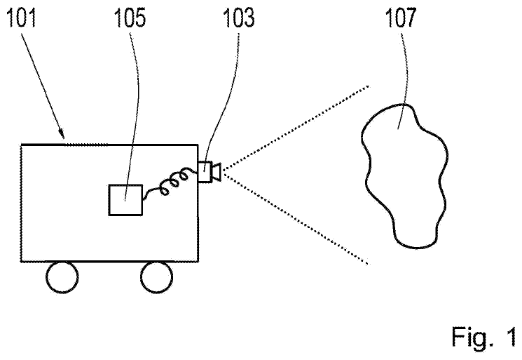

The vehicle 101 shown in FIG. 1 comprises a camera 103 and an evaluation unit 105. The camera 103 is connected for signal exchange with the evaluation unit 105. In the image area of the camera 103, i.e. in an area which is recorded by the camera 103, there is an object 107.

The evaluation unit 105 determines an optical flow of the object 107 in an image sequence recorded by the camera 103. In addition, the evaluation unit 105 determines a travel movement of the vehicle 101. From this an optical flow of the object 107 that is to be expected is obtained, which the evaluation unit 105 compares with the actual optical flow. If there are deviations, it can be concluded that the vehicle 101 is undergoing a tilting movement. In that event the evaluation unit 105 initiates countermeasures to stabilize the vehicle 101.

### INDEXES

101 Vehicle

103 Camera

105 Evaluation unit

107 Object

1. A method for recognizing a tilting movement of a vehicle (101) which comprises at least one camera (103) installed on the vehicle (101), the said method having the following steps:
recording of an image sequence by the camera (103);
determining an optical flow of the image sequence;
determining an optical flow to be expected on the grounds of a travel movement of the vehicle (101) and a topography of an underlying surface; and
checking of the optical flow of the image sequence and of the expected optical flow for deviations.

2. The method according to claim 1, wherein determining the optical flow to be expected comprises the following part-steps:
determining a travel movement of the vehicle (101);
determining a movement, of the camera (103) to be expected on the grounds of the travel movement and the topography, relative to at least one object (107) recorded by the camera (103); and
determining an optical flow to be expected on the grounds of the movement of the camera (103).

3. The method according to claim 2, wherein determining the optical flow to be expected comprises the following part-steps:
recognition of the object (107) in the image sequence;
determination of the optical flow of an area of the image sequence in which the object is depicted; and
determination of an optical flow of the said area to be expected due to the movement of the camera (103).

4. A vehicle (101) having at least one camera (103) and at least one control unit (105), wherein the at least one control unit (105) is configured to implement the method according to claim 1.

5. A vehicle (101) having at least one camera (103) and at least one control unit (105), wherein the at least one control unit (105) is configured to implement the method according to claim 2.

6. A vehicle (101) with at, least one camera (103) and at least one control unit (105), wherein the control unit (105) is configured to implement the method according to claim 3.
